(19) United States
(12) Patent Application Publication
(10) Pub. No.: US 2026/0326768 A1
(43) Pub. Date: Oct. 22, 2026

(54) VEHICULAR CONTROL SYSTEM WITH AUTOMATIC DRIVE MODE SELECTION

(71) Applicant: Magna Electronics Inc., Auburn Hills, MI (US)

(72) Inventors: Nanubala Guru Siva Prasad, Karnataka (IN); Ramallingeswara Rao P, Andhra Pradesh (IN)

(21) Appl. No.: 19/529,399

(22) Filed: Feb. 4, 2026

Related U.S. Application Data
(60) Provisional application No. 63/758,514, filed on Feb. 14, 2025.

(51) Int. Cl. B60W 30/182; B60W 10/30; B60W 50/08; B60W 50/14

(52) U.S. Cl. CPC B60W 30/182; B60W 10/30; B60W 50/082; B60W 50/14; B60W 2050/143; B60W 2050/146; B60W 2420/403; B60W 2510/1005; B60W 2552/10; B60W 2552/35; B60W 2555/20; B60W 2556/40; B60W 2556/50; B60W 2710/30

(57) ABSTRACT

A vehicular control system includes a GPS sensor disposed at a vehicle equipped with the vehicular control system. The vehicular control system, responsive to processing by the data processor of location data captured by the GPS sensor, and responsive to processing map data, determines the vehicle is approaching a condition. The vehicular control system, while the vehicle is operating in a first operational mode, and responsive to determining the vehicle is approaching the condition, (i) generates a mode change notification for a driver of the vehicle and (ii) switches from the first operational mode to a second operational mode. The second operational mode adjusts at least one selected from the group consisting of (a) a performance of the vehicle and (b) a fuel efficiency of the vehicle.

### CROSS REFERENCE TO RELATED APPLICATION

The present application claims the filing benefits of U.S. provisional application Ser. No. 63/758,514, filed Feb. 14, 2025, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular control system includes a GPS sensor disposed at a vehicle equipped with the vehicular control system. The GPS sensor captures location data. The system includes an electronic control unit (ECU) with electronic circuitry and associated software. The electronic circuitry of the ECU includes a data processor for processing location data captured by the GPS sensor. The vehicular control system, responsive to processing by the data processor of location data captured by the GPS sensor, and responsive to processing map data, determines the vehicle is approaching a condition. The vehicular control system, while the vehicle is operating in a first operational mode, and responsive to determining the vehicle is approaching the condition, (i) generates a mode change notification for a driver of the vehicle and (ii) switches from the first operational mode to a second operational mode. The second operational mode adjusts at least one selected from the group consisting of (a) a performance of the vehicle and (ii) a fuel efficiency of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a control system that incorporates cameras;

FIG. 2 is a perspective view of conventional selection switches for different drive modes;

FIG. 3 is a perspective view of a selection switch for an automatic drive mode of the system of FIG. 1; and

FIG. 4 is a block diagram of the control system of FIG. 1.

### DESCRIPTION OF THE PREFERRED EMBODIMENTS

A vehicle control system and/or driver or driving assist system and/or object detection system and/or alert system operates to automatically select or adjust or enable different drive modes (e.g., economy mode, power mode, comfort mode, sport mode, etc.). The system may capture images exterior of the vehicle and may process the captured image data to assist in selecting the mode appropriate for current environmental conditions. The control system includes a data processor or data processing system that is operable to receive image data from one or more cameras (and optionally one or more other sensors). Optionally, the vision system may provide a display, such as a rearview display or a top down or bird's eye or surround view display or the like.

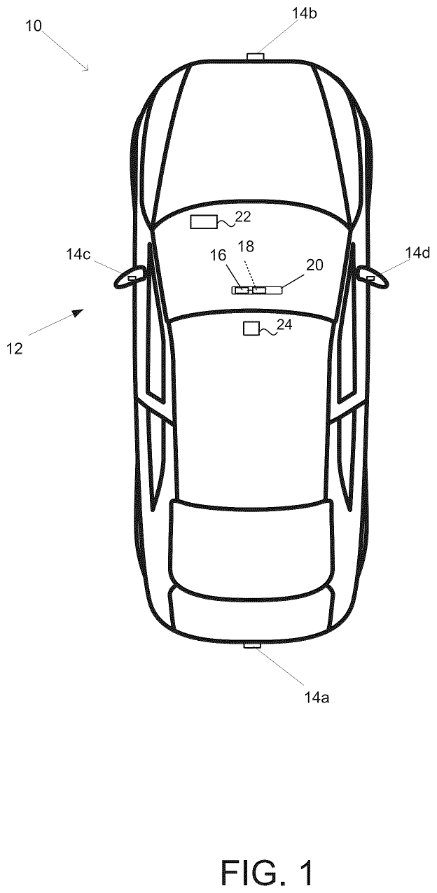

Referring now to the drawings and the illustrative embodiments depicted therein, a vehicle 10 includes a control system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The control system 12 includes a control or electronic control unit (ECU) 18 having electronic circuitry and associated software, with the electronic circuitry including a data processor or image processor that is operable to process image data captured by the camera or cameras, whereby the ECU may detect or determine current environmental conditions and/or presence of objects or the like. Optionally, the system provides displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). Optionally, the ECU processes data from other sensors, such as a rain or precipitation sensor 22. The ECU may receive input from one or more user inputs 24, such as a mode selection button or the like. The data transfer or signal communication from the camera to the ECU may comprise any suitable data or communication link, such as a vehicle network bus or the like of the equipped vehicle.

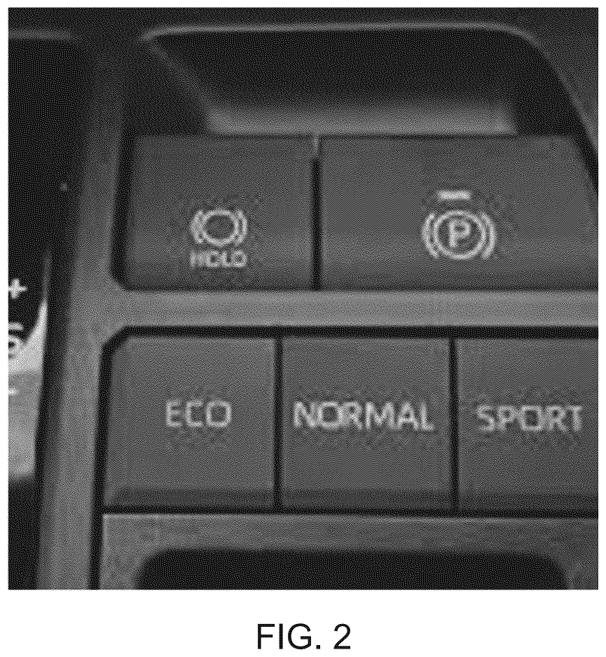

In modern automobiles, drivers have the option to select various drive modes such as Economy (“ECO”), Comfort, Normal, Power, and Sport, among others (FIG. 2). These modes are designed to optimize vehicle performance and efficiency based on different driving preferences and conditions, for example, by altering throttle mapping, transmission shift points, steering weight, and suspension damping characteristics. However, many drivers are not fully aware of the specific benefits and appropriate usage scenarios for each drive mode. For instance, a driver may remain in a Sport mode while cruising on a highway, resulting in unnecessary engine noise and reduced fuel economy due to maintained higher engine revolutions per minute (RPM). Conversely, a driver may remain in an ECO mode while attempting to merge onto a fast-moving freeway, potentially lacking the immediate throttle response required for the maneuver. This lack of understanding or situational awareness may lead to suboptimal driving experiences and inefficient vehicle operation. Additionally, some drive modes are tailored to specific environmental and road conditions, such as “Snow” or “Mud” modes that adjust traction control system (TCS) thresholds and torque distribution, further complicating the selection process for the driver. Currently, the responsibility of selecting the appropriate drive mode falls entirely on the driver, which may be cumbersome and prone to error, particularly when road conditions change rapidly, such as transitioning from paved asphalt to a gravel surface.

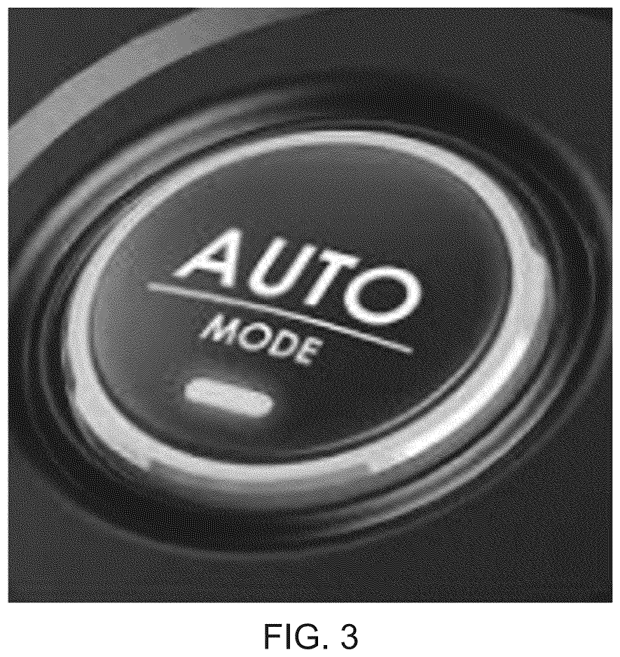

Implementations herein provide a vehicular control system or an automatic drive mode adjustment system that assists drivers by automatically selecting the optimal drive mode based on situational and environmental conditions, thereby eliminating the need for manual intervention. When the driver selects an “Auto Mode” (e.g., via a user input 24, such as a button, touch screen, switch, voice command, or gesture control) at, for example, the vehicle's head unit or center console, the system automatically and dynamically adjusts the drive mode (FIG. 3). This adjustment is based on real-time data inputs, including navigation data, road surface information from the front camera module (e.g., texture analysis determining asphalt, concrete, or dirt), and external temperature readings. The system may utilize sensor fusion techniques to correlate data from multiple sources, such as combining visual data indicating snow with temperature data indicating freezing conditions and wheel speed sensor data indicating slippage. By leveraging these inputs, the vehicle may seamlessly switch between drive modes to enhance performance, safety, and efficiency, such as by engaging four-wheel drive (AWD) upon detecting a loss of traction or stiffening suspension dampers upon detecting a winding road geometry via map data, providing a more intuitive and user-friendly driving experience. In some examples, the system may interface with a Controller Area Network (CAN) bus or an Ethernet network within the vehicle to send command signals to various sub-systems, such as the engine control module (ECM), transmission control module (TCM), and electronic stability program (ESP).

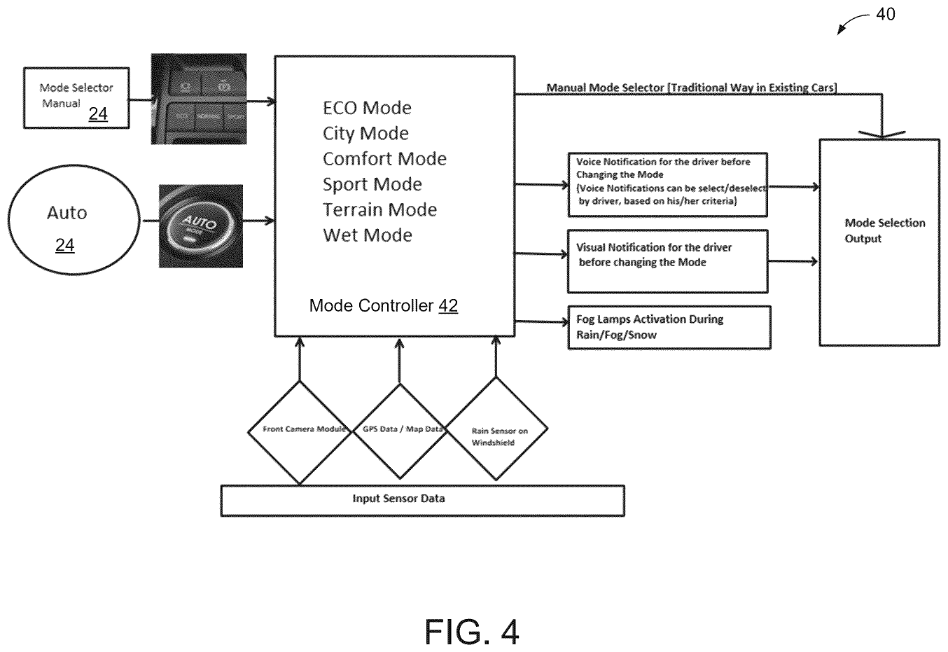

Referring now to FIG. 4, a block diagram 40 includes a mode controller 42, which may comprise a standalone electronic control unit (ECU) or a software module integrated within a body control module (BCM) or domain controller. The mode controller 42 may include a processor, memory, and communication interfaces for receiving and transmitting data over the vehicle network. The mode controller 42 receives various user inputs 24, such as manual mode selection inputs and/or an automatic or “auto” mode input. The mode controller 42 also receives or obtains data from one or more sensors, such as one or more cameras (e.g., monocular or stereo cameras for depth perception), radar sensors (e.g., long-range radar for object detection or adaptive cruise control), rain sensors, GPS sensors, Light Detection and Ranging (LiDAR) sensors, ultrasonic sensors, wheel speed sensors, steering angle sensors, yaw rate sensors, accelerometers, etc. The mode controller 42 may also receive map data from a map database or other source, such as a cloud-based server accessed via a telematics unit or a high-definition (HD) map stored locally in the vehicle memory. The map data may include static attributes, such as road curvature, gradient, speed limits, and surface type, as well as dynamic attributes received via Vehicle-to-Infrastructure (V2I) or Vehicle-to-Vehicle (V2V) communications, such as reported icing patches or traffic congestion.

The mode controller 42 uses the various inputs to intelligently and automatically select the optimal driving mode for the vehicle. For instance, the mode controller 42 may utilize a rule-based algorithm, a look-up table, or a machine learning model to correlate specific combinations of sensor data with specific vehicle configurations. When the mode controller 42 receives a manual mode selection user input 24, the system may switch to the selected mode by transmitting command signals to relevant vehicle subsystems, such as an engine control module (ECM) or transmission control module (TCM). When the driver selects the “Auto Mode” user input 24, the mode controller 42 may instead continuously monitor real-time data from multiple sensors and/or sources and switches between available modes appropriately (e.g., ECO mode, sport mode, comfort mode, AWD mode, etc.). In some examples, to prevent rapid cycling between modes during fluctuating conditions (e.g., intermittent traction loss), the mode controller 42 may implement a hysteresis loop or a time-delay buffer before executing a mode change. For example, if the system detects conditions suitable for “Sport Mode” based on accelerator pedal position and steering angle, the system may switch to Sport Mode and adjust the transmission shift points to hold gears longer and stiffen an active suspension system.

Optionally, the mode controller 42 receives GPS data and/or map data. Based on the GPS and/or map data indicating road attributes such as curvature, grade, surface type (e.g., gravel, paved), or speed limit data, the system may provide a notification to the driver within, for example, 500 meters (or within 1000 meters, or within 250 meters, etc.) before switching the drive mode. In some implementations, this distance threshold is dynamic and is calculated based on a current velocity of the vehicle to ensure the driver is provided a notification a set duration (e.g., 3 seconds, 5 seconds, 10 seconds) prior to the mode change. This notification ensures that the driver is aware of the impending change and can prepare to handle the vehicle accordingly. For example, when, based on map data, the system determines that the vehicle is approaching a different road type (e.g., a highway, a dirt road, etc.) that would benefit from a mode change, the system may notify or warn the driver (e.g., via a visual notification displayed on a display within the vehicle, such as an instrument cluster, a Head-Up Display (HUD), or a center infotainment screen, or an audible notification) of the impending mode change when the vehicle is a threshold distance away (e.g., 100 meters, 500 meters, 1000 meters). The notification may act as a prompt, allowing the driver to override the automatic selection if they choose. A visual notification may be complemented by a configurable voice notification, such as a text-to-speech announcement stating “Approaching highway, switching to Sport Mode,” which can be selected or deselected by the driver via the vehicle's head unit.

The mode controller 42 may take into account additional environmental conditions through various sensors at the vehicle, such as a rain sensor located at or near the windshield that detects moisture via optical reflection, infrared sensing, or capacitive sensing. For example, when the rain sensor detects precipitation and/or the windshield wipers are activated, the mode controller 42 may automatically adjust the drive mode to a “Wet Mode.” The wet mode may, for example, adjust a steering weight, torque delivery (e.g., reducing throttle sensitivity), or traction control system of the vehicle to better handle wet roads by increasing the sensitivity of an electronic stability control (ESC) system to detect and correct wheel slip earlier. Additionally or alternatively, the system may activate fog lights or other lights to improve visibility upon detecting reduced visibility conditions via image processing of data from the front camera module. This seamless transition to the wet mode ensures that the vehicle is better equipped to handle adverse weather conditions, thereby enhancing safety. The system may additionally or alternatively receive weather data from a remote server via a telematics control unit or a connected mobile device and adjust the current operational mode based at least in part on the weather data, for example, by pre-conditioning the vehicle for “Snow Mode” if local weather reports indicate freezing temperatures and snowfall.

The mode controller 42 may maintain or persist the selected auto mode even after the vehicle's ignition is turned off and then back on, for example, by storing the last known state of the mode selection in a non-volatile memory (e.g., EEPROM or Flash memory) associated with the ECU 18 or a specific user profile linked to a key fob. This feature ensures that the vehicle remains in the optimal driving mode without requiring the driver to reselect it each time the vehicle is started. However, the driver may retain the flexibility to manually deselect the auto mode (and manually select a desired mode) if desired via the user inputs 24, such as by rotating a drive mode selector knob or selecting a soft-key on a touch screen interface. Optionally, when the vehicle is put into reverse gear, as detected by a transmission gear sensor or a signal over the vehicle's Controller Area Network (CAN) bus, the mode controller 42 automatically sets the drive mode to a particular or default mode (e.g., comfort mode or city mode). This default setting provides a smoother and more controlled driving experience during maneuvers that typically require lower speeds and/or greater precision, such as reversing maneuvers. For instance, in the default mode during reverse operation, the throttle mapping may be dampened to reduce sensitivity, and the steering assist may be increased to facilitate easier maneuvering in tight parking spaces.

In some examples, the mode controller 42 leverages GPS and/or map data to adjust the drive mode during specific driving scenarios, such as traversing entry ramps, exit ramps, and/or speed bumps. In these situations, the system may switch to, for example, comfort mode to provide softer suspension stiffness and a more sensitive throttle response, or conversely, to a sport mode when entering a highway on-ramp to provide increased torque availability for merging with high-speed traffic. This adjustment enhances the vehicle's ability to navigate these conditions smoothly and comfortably, thereby improving the overall driving experience. Specifically, regarding speed bumps, the mode controller 42 may identify the location of a speed bump via map data or via object detection analysis of images from the camera 14b and proactively adjust an active suspension system to increase damping compliance just prior to impact. Optionally, the system may store previous mode selections made by the driver at different geographical locations and may automatically switch to the previously selected mode when the vehicle (during a subsequent drive) approaches one of the geographical locations. For example, the system may learn that the driver selects “sport” mode at a particular winding road and may store that selection associated with map data or GPS coordinates (e.g., latitude and longitude), and the system may later automatically switch to the sport mode when the vehicle approaches the particular winding road during a subsequent drive. The system may learn habits or preferences of the driver based on historical driving data, such as by populating a database or lookup table that correlates driver selections with specific times of day, locations, and weather conditions. For example, when the driver manually selects a specific mode during particular environmental conditions, when in Auto mode, the system may select the same specific mode during similar environmental conditions.

By integrating these various inputs and intelligent adjustments, the mode controller 42 ensures that the vehicle operates in the most suitable drive mode or driver-preferred drive mode for any given situation, enhancing performance, safety, and driver convenience. For example, in an electric vehicle implementation, the mode controller 42 may automatically switch to an ECO mode with high regenerative braking when map data indicates a long downhill gradient, thereby maximizing energy recovery. The system may utilize aspects described in U.S. Publication No. US-2024-0367665, which is hereby incorporated herein by reference in its entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, the vehicular control system comprising:
a GPS sensor disposed at a vehicle equipped with the vehicular control system, the GPS sensor capturing location data;
an electronic control unit (ECU) comprising electronic circuitry and associated software;
wherein the electronic circuitry of the ECU comprises a data processor for processing location data captured by the GPS sensor;
wherein the vehicular control system, responsive to processing by the data processor of location data captured by the GPS sensor, and responsive to processing map data, determines the vehicle is approaching a condition; and
wherein the vehicular control system, while the vehicle is operating in a first operational mode, and responsive to determining the vehicle is approaching the condition, (i) generates a mode change notification for a driver of the vehicle and (ii) switches from the first operational mode to a second operational mode, and wherein the second operational mode adjusts at least one selected from the group consisting of (a) a performance of the vehicle and (b) a fuel efficiency of the vehicle.

2. The vehicular control system of claim 1, wherein the mode change notification is a visual notification.

3. The vehicular control system of claim 1, wherein the mode change notification is an audible notification.

4. The vehicular control system of claim 1, wherein the vehicular control system generates the mode change notification when the vehicle is a threshold distance from the condition.

5. The vehicular control system of claim 4, wherein the threshold distance is 500 meters.

6. The vehicular control system of claim 1, further comprising a precipitation sensor, and wherein the vehicular control system, while the vehicle is operating in the second operational mode, switches from the second operational mode to a third operational mode based at least in part on data captured by the precipitation sensor.

7. The vehicular control system of claim 6, wherein the vehicular control system activates fog lights of the vehicle based at least in part on data captured by the precipitation sensor.

8. The vehicular control system of claim 1, wherein the vehicular control system, while the vehicle is operating in the second operational mode, and responsive to determining that the vehicle is in a reverse gear, switches from the second operational mode to a third operational mode.

9. The vehicular control system of claim 1, wherein the condition comprises one selected from the group consisting of (i) an entry ramp, (ii) an exit ramp and (iii) a speed bump.

10. The vehicular control system of claim 1, further comprising a camera, and wherein the vehicular control system, while the vehicle is operating in the second operational mode, switches from the second operational mode to a third operational mode based at least in part on image data captured by the camera.

11. The vehicular control system of claim 10, wherein the vehicular control system activates fog lights of the vehicle based at least in part on image data captured by the camera.

12. The vehicular control system of claim 1, wherein the first operational mode comprises one selected from the group consisting of (i) an economy mode, (ii) a power mode, (iii) a sport mode, (iv) a city mode, (v) a terrain mode and (vi) a wet mode.

13. A method for controlling a vehicle, the method comprising:
capturing location data via a GPS sensor disposed at the vehicle;
processing, by a data processor of an electronic control unit (ECU), the location data captured by the GPS sensor;
determining, based on processing the location data and map data, that the vehicle is approaching a condition; and
while the vehicle is operating in a first operational mode, and responsive to determining the vehicle is approaching the condition, (i) generating a mode change notification for a driver of the vehicle and (ii) switching from the first operational mode to a second operational mode, wherein the second operational mode adjusts at least one selected from the group consisting of (a) a performance of the vehicle and (b) a fuel efficiency of the vehicle.

14. The method of claim 13, wherein generating the mode change notification comprises generating a visual notification.

15. The method of claim 13, wherein generating the mode change notification comprises generating an audible notification.

16. The method of claim 13, comprising generating the mode change notification when the vehicle is a threshold distance from the condition.

17. The method of claim 16, wherein the threshold distance is 500 meters.

18. The method of claim 13, further comprising receiving data from a precipitation sensor, and switching, while the vehicle is operating in the second operational mode, from the second operational mode to a third operational mode based at least in part on the data received from the precipitation sensor.

19. The method of claim 18, further comprising activating fog lights of the vehicle based at least in part on the data received from the precipitation sensor.

20. The method of claim 13, further comprising determining that the vehicle is in a reverse gear, and switching, while the vehicle is operating in the second operational mode, from the second operational mode to a third operational mode responsive to determining that the vehicle is in the reverse gear.
